(19) United States
(12) Patent Application Publication
(10) Pub. No.: US 2018/0369860 A1
(43) Pub. Date: Dec. 27, 2018

(54) SYSTEM AND APPARATUS FOR APPLYING PAINT TO A SURFACE

(71) Applicant: DAMAC IP HOLDINGS PTY LTD, VIC (AU)

(72) Inventors: David DALY, Keysborough (AU); Glen MCCULLOCH, Seaford (AU)

(73) Assignee: DAMAC IP HOLDINGS PTY LTD, Currum Downs, Victoria (AU)

(21) Appl. No.: 15/741,480

(22) PCT Filed: Jul. 4, 2016
(86) PCT No.: PCT/AU2016/000241

§ 371 Date: Jan. 2, 2018

(30) Foreign Application Priority Data
Jul. 3, 2015 (AU) 2015902631

(51) Int. Cl. B05D 3/04; B05C 11/10; B05C 17/00; B05C 17/03

(52) U.S. Cl. CPC B05D 3/0493; B05C 11/1039; B05D 1/02; B05C 17/0308; B05C 17/002

(57) ABSTRACT

There is disclosed a paint application system. The paint application system comprises an applicator for applying paint to a surface to be painted and a supply unit in fluid communication with the application and having a positive pressure source for supplying paint to the applicator and a negative pressure source for supplying a negative pressure to the applicator. Both the paint and the negative pressure are supplied to the applicator at the same time such that any excess paint present at the applicator during the application of the paint to the surface to be painted is collected by the negative pressure at the applicator and removed from the applicator.

### RELATED APPLICATIONS

The present application claims priority from Australian provisional patent application No. 2015902631 filed 3 Jul. 2015, the entire contents of which are incorporated herein by reference.

### FIELD OF INVENTION

The present invention relates generally to a system and apparatus for applying a fluid to a surface, and in particular, to a system and apparatus for applying paint to a surface by way of an applicator capable of receiving paint under pressure for applying to the surface and which incorporates a negative pressure about the perimeter of the applicator for removing any excess paint during the application process.

### BACKGROUND OF THE INVENTION

The act of applying paint, or a similar fluid, to a surface in a consistent and aesthetically pleasing manner requires considerable skill and expertise to perform correctly. Typically, an applicator, such as a brush, roller or pad, is dipped into a paint source or supply and that paint is applied directly to the surface to be painted by the applicator. Typically, the surface is a wall or similar structure surface. The manner in which the paint is applied is largely determinant upon the type of applicator being used, with a brush or roller being the most common types of applicators used.

Historically, the act of painting has been a messy job due largely in the need to transfer the paint from a can or tray to the surface to be painted without the paint dripping from the applicator during the transfer process. Similarly, depending on the surface to be painted, there may be a requirement to use a variety of different applicators to perform the task, with those areas of the surface located close to edges or window frames requiring particular care in order to prevent paint from being applied to areas where it is not intended to be applied.

In order to address the amount of mess created, a variety of application systems have been proposed which supply paint to an applicator from a remote paint supply under pressure. By supplying a constant supply of paint to an applicator, there is a reduction in the need for the applicator to be constantly dipped in the paint supply and for the applicator to be then transferred to the surface to be painted, thereby reducing the source of some of the mess typically associated with painting. However, such powered paint supply systems generally suffer from an inability to regulate the amount or flow rate of the paint being supplied to the applicator which can result in significant excess paint accumulating at the applicator, especially during times where care is required and the painter slows down their strokes, which can result in inadvertent dripping of the paint on the surface of the structure being painted, as well as inconsistence in the amount of paint being applied by the applicator at such regions. Both of which result in a less than desired paint finish.

To address such supply regulation problems, many existing painting devices have employed sensors and the like at the applicator so as to sense the state of the applicator to determine when the applicator is in use or idle. If the applicator is sensed as being idle, the pump may shut-off, or operate in reverse, to draw paint away from the applicator to reduce the likelihood of paint accumulating at the applicator and dripping therefrom when not in use. However, such devices are complicated and add to the overall cost of the painting system and function to deal with the accumulation of excess paint after it has occurred, rather than avoiding the accumulation of paint in the first instance.

Thus, there is a need to provide a system and apparatus for applying a fluid, such as paint, to a surface whereby the paint is supplied under pressure to an applicator which constantly removes any excess paint accumulating at the applicator during the painting process.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a paint application system comprising:
an applicator for applying paint to a surface to be painted; and
a supply unit in fluid communication with the application and having a positive pressure source for supplying paint to the applicator and a negative pressure source for supplying a negative pressure to the applicator;
wherein both the positive pressure source and the negative pressure source are supplied to the applicator at the same time such that any excess paint present at the applicator during the application of the paint to the surface to be painted is collected by the negative pressure source at the applicator and removed from the applicator.

The negative pressure may be supplied to the applicator so as to be directed about a periphery of the applicator. In one form, the applicator may be a pad and the negative pressure may be directed about a periphery of the pad. In another form, the applicator may be a brush, and the negative pressure may be directed about a periphery of the brush. In another form, the applicator may be a roller and the negative pressure may be directed about a periphery of the roller. In another form, the applicator may be a spray gun and the negative pressure may be directed about the periphery of the spray gun.

The negative pressure and the paint may be supplied to the applicator by way of a pair of tubes arranged in a substantially co-axial manner.

Any excess paint collected by the negative pressure source may be returned to the supply unit for storage.

The supply unit may comprise a return reservoir for collecting the excess paint collected from the applicator by the negative pressure.

According to another aspect, there is provided a method of painting a surface comprising:
supplying paint from a paint source to an applicator for application to the surface;
supplying a negative pressure to the applicator to collect any excess paint being applied to the applicator from the paint source; and
removing and collecting the excess paint.

The step of supplying paint from a paint source may comprise supplying paint under pressure to the applicator under pressure.

The step of supplying a negative pressure to the applicator may comprise supplying negative pressure from a negative pressure source to the applicator. The step of supplying negative pressure to the applicator may comprise supplying the negative pressure to the applicator such that it is distributed about a periphery of the applicator.

The step of removing and collecting the excess paint may also comprise delivering the excess paint from the applicator to a collection reservoir. The collection reservoir may be located remote from the applicator.

### BRIEF DESCRIPTION OF THE DRAWINGS

The invention may be better understood from the following non-limiting description of preferred embodiments, in which:

FIG. 1 is a side view of the paint applicator apparatus of the present invention in use in accordance with a first embodiment;

FIG. 2 is a plan view of the paint applicator apparatus of FIG. 1;

FIG. 3 is a cross-sectional side view of the applicator of the paint applicator apparatus of FIG. 1;

FIG. 4 is top view of the applicator of the paint applicator apparatus of FIG. 1 with the applicator pad removed;

FIG. 5 is a perspective view of the paint application system of the present invention.

FIG. 6 is a plan view of a paint applicator in accordance with another embodiment of the present invention.

FIG. 7 is a partial side view of a means for connecting a handle with the paint applicator of FIG. 6; and

FIG. 8 is a partial top view of a means for connecting a handle with the paint applicator of FIG. 6

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described below in relation to its application for use with an applicator having a substantially rectangular pad type application surface commonly used for painting along an edge of a surface. However, it will be appreciated that the system and apparatus of the present invention could be used with a variety of different types and shapes of applicators as will be appreciated by those skilled in the art.

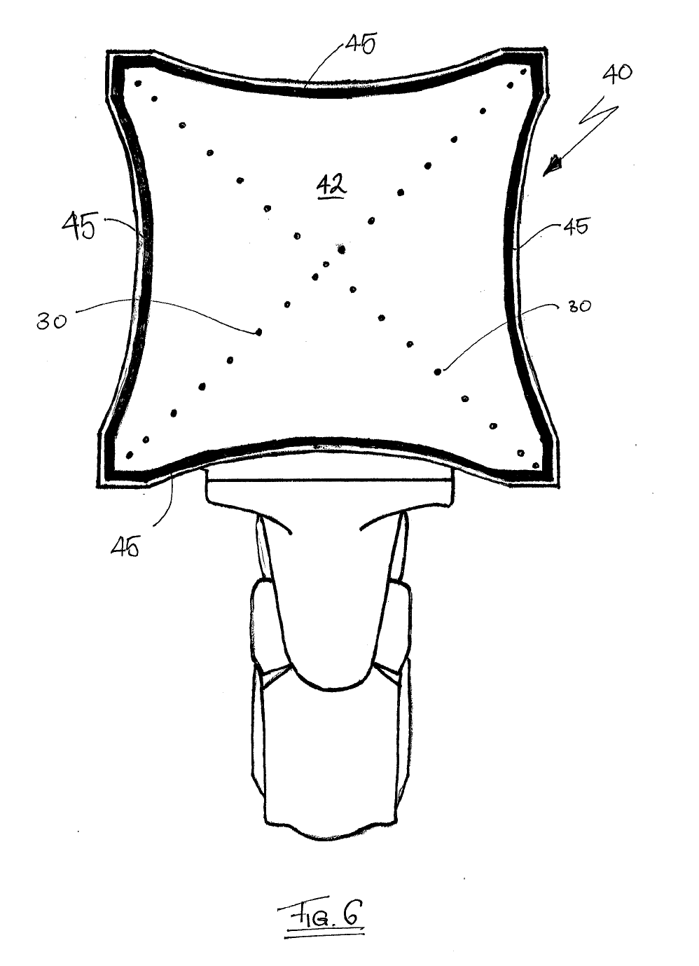

Referring to FIG. 5, a paint application system 10 in accordance with an embodiment of the present invention is shown. The application system 10 comprises an applicator 12 having a substantially rectangular body for applying paint to a surface, such as a surface of a wall or the like. The applicator 12 is provided with a handle 14 that extends from a mounting 13 provided on the rear surface of the body of the applicator 12. The handle 14 is configured to pivotally engage with the applicator 12 at the mounting 13 to enable the applicator 12 to be used in an extended form, as depicted. In an alternative embodiment, the end of the handle may terminate in a ball or rounded member that is received by the mounting 13, which is in the shape of a cup. This ball and cup engagement may provide close to 360° movement of the handle 14 with respect to the applicator 12, thereby increasing the degree of handling of the system and its usability. The handle 14 may be provided with a trigger or controller 15 so as to provide the user of the system 10 with control of the state of the system. In this regard, the trigger or controller 15 may be provided with an on/off switch to turn the system 10 on or off during the painting motion. Whilst not shown, the handle 14 may be provided with one or more extending portions to extend the length of the arrangement, especially when the system is to be used to paint high walls or ceilings. It will be appreciated that the system 10 of the present invention may be used without an extension and may have a different handle arrangement, as will be appreciated by those skilled in the art.

A tube 16 may extend from rear surface of the applicator 12 to a supply unit 18. The supply unit 18 comprises a housing that houses a supply reservoir of paint (not shown) for application to the surface via the applicator 12 and also a pump (not shown) for supplying the paint to the applicator 12 under pressure. The supply unit 18 also contains a secondary or return reservoir (not shown) for receiving excess paint from the applicator 12, as will be described in more detail below.

In a preferred embodiment, the pump is configured to supply both a positive pressure for delivering the paint from the supply reservoir to the applicator, and a negative pressure (or vacuum) for drawing excess paint from the applicator 12 back to the secondary or return reservoir, as required. In an alternative embodiment, two pumps may be provided within the supply unit 18 for achieving this purpose.

In a preferred embodiment, the system of the present invention comprises a single tube 16 comprising of an inner tube 16a and an outer tube 16b arranged in a substantially coaxial manner. The inner tube 16a has a smaller diameter than the outer tube 16b and is configured to deliver the paint to the applicator 12, whilst the larger diameter outer tube 16b is attached to the pump to deliver a negative or vacuum pressure to the applicator 12 to facilitate the removal of any excess paint from the applicator 12 during use. The provision of a single, coaxial tube 16 that is capable of delivering both paint and a negative pressure to the applicator 12 reduces the need to attach multiple tubes to the applicator 12 for this purpose. In an alternative embodiment, the coaxial tube 16 may be housed within the handle 14 and where applicable, any extension, such that the tube 16 is largely concealed from view and makes the handle easier to grip and use. However, it will be appreciated that in some embodiments, separate tubes for supplying the paint to the applicator 12 and removing excess paint from the applicator 12 may also be employed and these separate tubes may be located internal or external the handle 14.

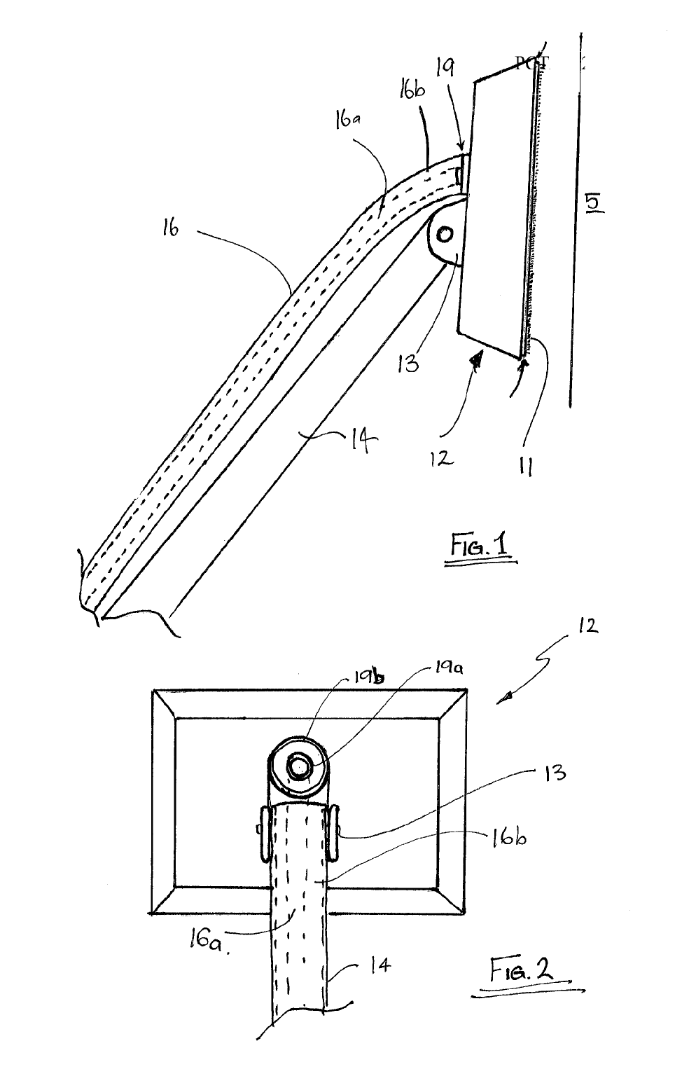

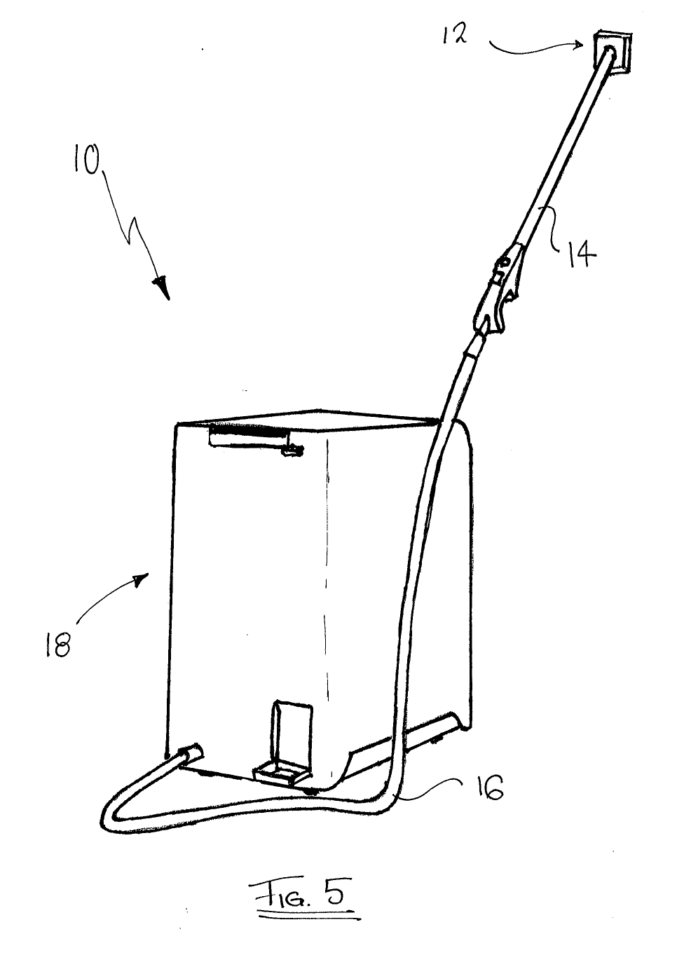

Referring to FIGS. 1-3, one embodiment of the applicator is depicted, showing the manner in which the tube 16 may be connected to the applicator 12. In this embodiment, the rear surface of the applicator 12 has a connector 19 having in inner connector 19a configured to sealingly engage with the inner tube 16a and an outer connector 19b configured to sealingly engage with the outer tube 16b. As is shown more clearly in FIG. 3, the inner connector 19a extends beyond the outer connector 19a to act as a male connector that is received within the inner tube 16a to create a sealed connection therebetween. In this regard, an O-ring may be provided on the outer surface of the inner connector 19a to facilitate a seal between the inner tube 16a and the inner connector 19a. Similarly, the external surface of the outer connector 19b may be provided with one or more O-rings to facilitate sealing engagement between the outer tube 16b and the outer connector 19b.

The manner in which the applicator 12 functions to provide a controlled amount of paint to the surface 5 to be painted can be seen more clearly in relation to FIGS. 3 and 4.

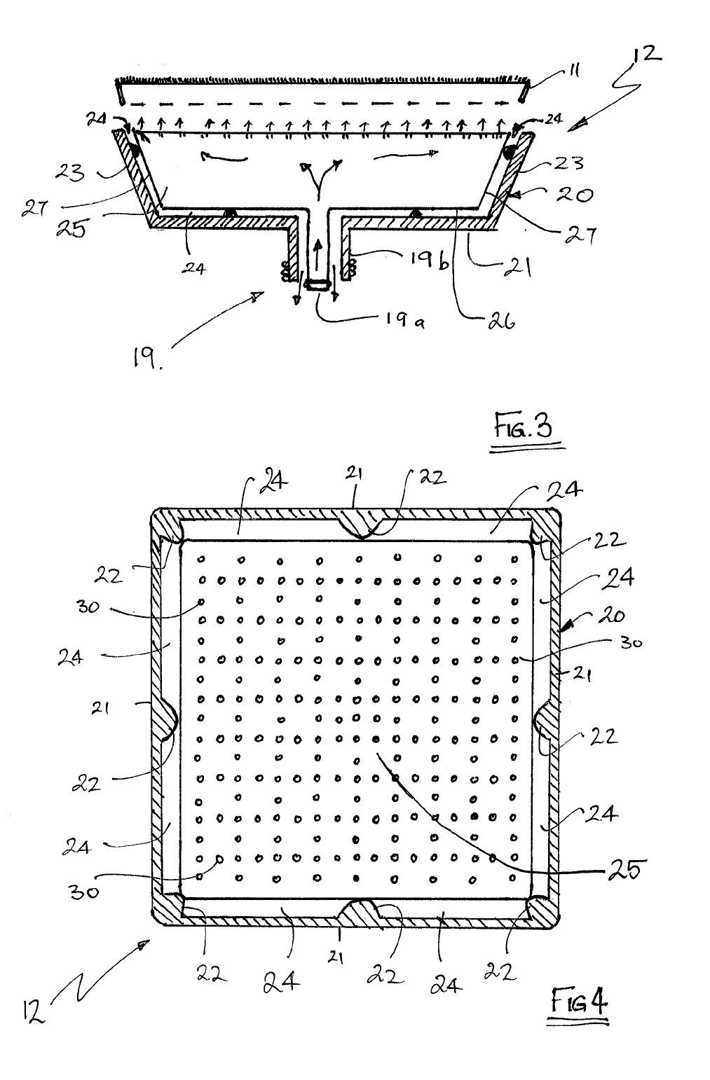

The applicator 12 comprises a body member 20 that defines the external shape of the applicator. In this regard, the body 20 has a rear surface 21 that has the mounting 13 and the outer connector 19b formed thereon to facilitate connection between the handle 14 and the applicator 12 and the tube 16 and the applicator 12 respectively. The rear surface 21 is substantially rectangular in configuration as is shown in FIG. 2, and has four side walls 23 that project therefrom in an outwardly angular manner, as is shown in FIG. 3.

The body member 20 defines an open topped body into which the distributing member 25 is able to be received. The distributor member 25 comprises a substantially hollow body that is able to receive paint from the inner tube 16a and store the paint in the body for application to the wall surface 5. As the paint is received into the distributor member 25 under pressure, the distributor member 25 is able to fill with paint. The inner surface of the body member 20 is provided with seat members 22 formed thereon, in the form of projections provided on the body surface. The distributor member 25 has a bottom surface 26 and side walls 27 that are shaped to substantially conform to the inner shape of the body member 20. In this regard, when the distributor member 25 is placed within the body member 20, it is received on the seat members 22 such that there is a gap 24 formed between the inner surface of the body member 20 and the outer surface of the distributor member 25. This gap 24 is in direct communication with the outer tube 16b so as to form a vacuum about the perimeter of the distributor member 25, for collecting any excess paint and returning the excess paint back to the supply unit 18.

The upper surface of the distributor member 25 is depicted more clearly in FIG. 5. The upper surface comprises a number of holes 30 formed thereover at substantially regular intervals to provide a means for releasing paint from the distributor member 25 to the pad 11 that is fitted over the upper surface of the distributor member 25 when in use. In use, the pad 11 becomes saturated with paint released from the hollow body of the distributor member 25 such that the paint is evenly distributed across the pad 11 so as to be evenly applied to the surface 5 as required. As the paint is supplied under a positive pressure, there is a constant release of paint from the distributor member 25 to the pad 11, which may be controlled by the user by way of the trigger 15 or a preconditioned pressure supply setting.

The pad 11 may be made from any number of conventional materials that may be used in painting to apply paint to a surface and is replaceable when required. As the pad 11 is configured to attach to the upper surface of the distributor member 25, it can be readily removed and replaced, when required.

Due to the angled nature of the walls 23 of the body member 20, the applicator 12 of the present embodiment is capable of performing edging or “cutting-in” as it can be positioned closely to edges, such as window frames or door frames to perform a clean painted edge without applying paint to any unwanted surfaces.

Due to the provision of the vacuum gap 24 around the perimeter of the upper surface of the distributor member 25, any excess paint that may travel into this region will be collected by the negative pressure created in this region and returned to the supply unit for reuse or disposal, as appropriate. As depicted in FIG. 1, in use the applicator 12 will typically be orientated in a substantially vertical plane and as such, any excess paint may move to the lower edge of the pad 11 where it may have a tendency to drip to the floor below. However, due to the provision of the vacuum gap 24 along the periphery of this region, any potential drips will be captured by the applicator and contained within the system.

As the negative pressure is constantly supplied with the positive supply pressure, the likelihood of a build-up of excess paint at the applicator is significantly reduced, as excess paint is removed from the applicator as it forms. It will be appreciated that the negative pressure may be operated independently of the positive supply pressure such that when the supply pressure is deactivated to stop paint flow, the negative pressure generated about the periphery of the applicator is maintained for a predetermined time to collect any residual leakages of paint that may result. It will also be appreciated that the manner in which the positive and the negative pressure is controlled could vary considerably between applications, with the main issue being that during use, the positive and negative pressure work at the same time to confine the paint to the applicator surface and prevent excess paint building up and creating a mess or reducing the quality of the painting.

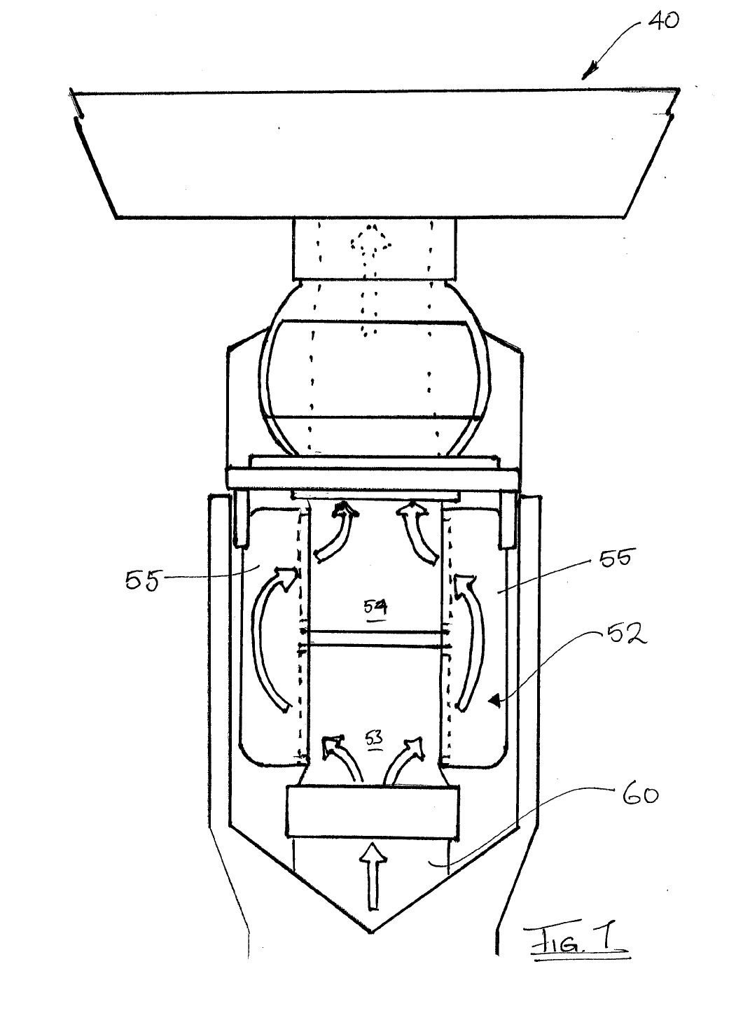

An alternative embodiment of an applicator to be used with a paint applicator system 10 of the present invention is shown in FIG. 6 as reference numeral 40. This applicator 40 has a substantially rectangular work surface 42, with the sides connecting each of the edges being curved. Rather than the work surface 42 having holes 30 formed over the entire work surface 42, the holes 30 are arranged in a pair of intersecting diagonal lines. Such a means for supplying paint to the work surface 42 and any pad that may be located thereon ensures that there is not an oversupply of paint, which could result in excess paint being removed from the applicator 12 via the vacuum return circuit 45, which is formed around the perimeter of the work surface 42, which is represented by the dark region. It will be appreciated that the number of holes 30 and the pattern upon which they are provides on the work surface 42 may vary depending upon a variety of working conditions.

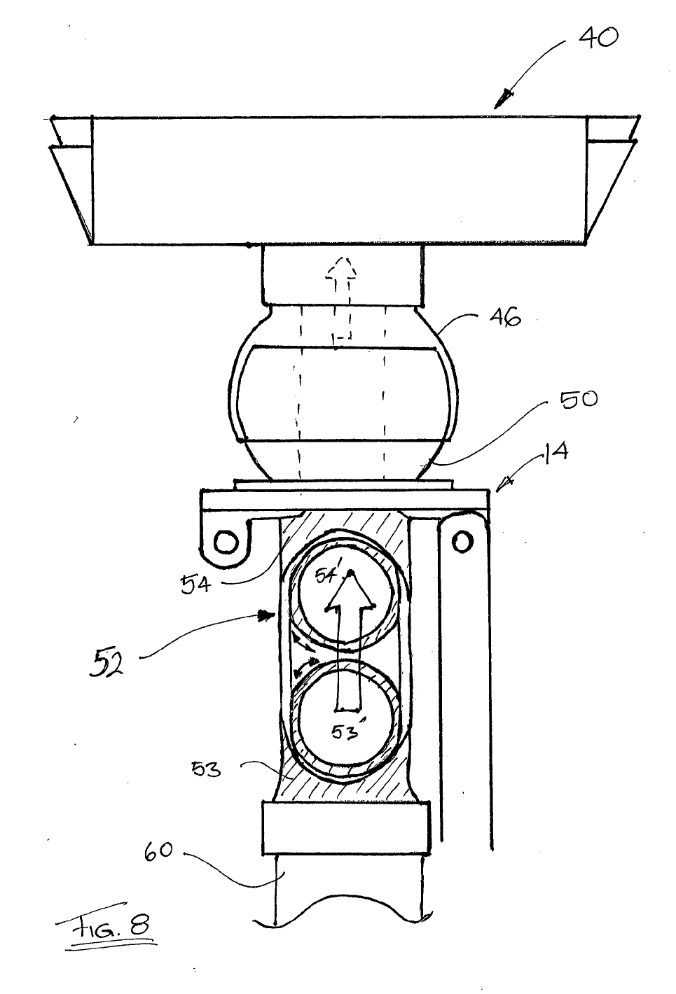

FIGS. 7 and 8 depict an alternative connection means for connecting the handle 14 and paint supply tube 16 to the rear of the applicator 40. The vacuum tube is not shown for clarity purposes.

The manner in which the handle 14 connects to the rear of the applicator 40 is via a ball and cup arrangement, to facilitate multiple degrees of movement of the applicator 40 with respect to the handle 14. In this regard, a cup member 46 extends from the rear surface of the applicator 40, as shown, to receive a ball member 50 connected at the end of the handle 14. The ball member 50 is seated within the cup member 46 to facilitate movement of the applicator 40 with respect to the handle 14 in multiple directions.

A fluid transfer mechanism 52 is also depicted to facilitate transfer of fluid, namely paint, from the supply tube 60 to the applicator 40. It will be appreciated that as the supply tube 60 carries paint from the reservoir to the applicator, the tube 60 will develop a degree of rigidity which may adversely affect the flexible link between the applicator 40 and the handle 14. To address this, the fluid transfer mechanism 52 comprises to separate transfer bodies, a lower transfer body 53 and an upper transfer body 54. The lower transfer body 53 receives the paint from the supply tube 60 and has an open cylindrical passage 53′ extending transverse to the direction of flow of the paint from the tube 60, to enable the paint to travel in an orthogonal direction to pass through a pair of connecting channels 55 that connect between the open cylindrical passage 53′ of the lower transfer body 53 and the open cylindrical passage 54′ of the upper transfer body 54, which is substantially identical in configuration to the lower transfer body. The paint can then pass from the lower transfer body 53 to the upper transfer body 54 as depicted by the arrows, to then flow into the applicator 40.

Each of the lateral sides of the respective open cylindrical passages 53′ and 54′ of the lower transfer body 53 and the upper transfer body 54 are pivotally mounted to the connecting channels 55. This enables the lower transfer body 53 and the upper transfer body 54 to pivotally move with respect to each other as depicted by the arrows in FIG. 8. This reduces the rigidity of the paint delivery tube at the connection between the applicator 40 and the handle 14, to maintain a device that is simple to use and easy to manipulate into a desired position. It will be appreciated that whilst the fluid transfer mechanism 52 is able to achieve this flexibility, this can be achieved by a variety of different mechanisms which provide flexibility and individual movement, as will be appreciated by those skilled in the art. Further, the ball member 50 and cup member 46 provide a simple detachment means for detaching and cleaning the system after use. This enables different parts to be interchanged for use and cleaning as desired by the user.

It will be appreciated that system of the present invention may be made in a variety of ways depending upon the intended purpose of use. In this regard, the system may be configured as a portable system with the paint reservoir carried in a backpack arrangement. In another embodiment, the system may be configured to receive one or more commercially available paint cartridges to provide a simplistic means for users to simply insert a cartridge of the desired type or colour of paint, thereby minimising cleaning and maintenance of the system. As previously mentioned, the applicators may be in any number of sizes and shapes and the manner in which the returned paint is disposed or reused, can vary depending upon the requirements of the user.

It will be appreciated that by providing a system for applying paint or similar fluid to a surface that can simultaneously recover any excess fluid present during the application process, the system is able to simply and effectively reduce mess and potential wastage and provides a system that has an enhanced ability to provide a more cleaner finish, irrespective of the talent and/or experience of the user.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the apparatus uppermost.

It will be appreciated by those skilled in the art that many modifications and variations may be made to the methods of the invention described herein without departing from the spirit and scope of the invention.

The claims defining the invention are as follows:

1. A paint application system comprising:
an applicator for applying paint to a surface to be painted; and
a supply unit in fluid communication with the application and having a positive pressure source for supplying paint to the applicator and a negative pressure source for supplying a negative pressure to the applicator;
wherein both the paint and the negative pressure are supplied to the applicator at the same time such that any excess paint present at the applicator during the application of the paint to the surface to be painted is collected by the negative pressure at the applicator and removed from the applicator.

2. A paint application system according to claim 1, wherein the negative pressure is supplied to the applicator so as to be directed about a periphery of the applicator.

3. A paint application system according to claim 2, wherein the applicator is a pad and the negative pressure is directed about the periphery of the pad.

4. A paint application system according to claim 2, wherein the applicator is a brush and the negative pressure is directed about the periphery of the brush.

5. A paint supply system according to claim 2, wherein the applicator is a roller and the negative pressure is directed about the periphery of the roller.

6. A paint application system according to claim 2, wherein the applicator is a spray gun and the negative pressure is directed about the periphery of the spray gun.

7. A paint application system according to claim 2, wherein, the negative pressure and the paint are supplied to the applicator by way of a pair of tubes arranged in a substantially co-axial manner.

8. A paint application system according to claim 7, wherein any excess paint collected by the negative pressure source is returned to the supply unit for storage.

9. A paint application system according to claim 8, wherein the supply unit comprises a return reservoir for collecting the excess paint collected from the applicator by the negative pressure.

10. A method of painting a surface comprising:
supplying paint from a paint source to an applicator for application to the surface;
supplying a negative pressure to the applicator to collect any excess paint being applied to the applicator from the paint source; and
removing and collecting the excess paint.

11. A method according to claim 10, wherein the step of supplying paint from a paint source comprises supplying paint under pressure to the applicator under pressure.

12. A method according to claim 10, wherein the step of supplying a negative pressure to the applicator comprises supplying negative pressure from a negative pressure source to the applicator.

13. A method according to claim 12, wherein the step of supplying negative pressure to the applicator comprises supplying the negative pressure to the applicator such that it is distributed about a periphery of the applicator.

14. A method according to claim 10 wherein the step of removing and collecting the excess paint comprises delivering the excess paint from the applicator to a collection reservoir.

15. A method according to claim 14, wherein the collection reservoir is located remote from the applicator.
